(19) United States
(12) Patent Application Publication
(10) Pub. No.: US 2018/0035406 A1
(43) Pub. Date: Feb. 1, 2018

(54) METHOD AND APPARATUS FOR SELECTING AND DETERMINING MODULATION CODING MODE IN WIRELESS COMMUNICATION SYSTEM

(71) Applicant: Samsung Electronics Co., Ltd, Gyeonggi-do (KR)

(72) Inventors: Chenxi Hao, Beijing (CN); Jingxing Fu, Beijing (CN); Chen Qian, Beijing (CN); Bin Yu, Beijing (CN); Qi Xiong, Beijing (CN)

(21) Appl. No.: 15/662,213

(22) Filed: Jul. 27, 2017

(30) Foreign Application Priority Data
Jul. 27, 2016 (CN) 201610601910.4

(51) Int. Cl. H04W 72/02; H04L 5/00; H04W 52/24; H04W 52/10; H04W 52/26; H04W 72/08

(52) U.S. Cl. CPC H04W 72/02; H04W 52/262; H04W 72/082; H04W 52/243; H04W 52/10; H04L 5/0007

(57) ABSTRACT

The present disclosure provides a method for selecting a modulation and coding scheme (MCS) and the number of resource blocks, comprising the following steps of: selecting, by a terminal apparatus, an MCS and the number of resource blocks for uplink data transmission according to power control information, channel state information, multiple access resource information, the size of a data packet and/or interference intensity information; and, partitioning resource blocks within a frequency band according to a pre-defined resource partitioning and mapping pattern, and transmitting data through the partitioned resource block combination, the partitioned resource block combination being corresponding to the selected MCS and the selected number of resource blocks.

### PRIORITY

The present application is related to and claims priority under 35 U.S.C. § 119 to Chinese Patent Application No. 201610601910.4 filed on Jul. 27, 2016, the contents of which are incorporated herein by reference.

### TECHNICAL FIELD

The present disclosure generally relates to a wireless communication system, and in particular to a method and an apparatus for selecting a modulation and coding scheme (MCS) and the number of resource blocks and for determining an MCS and the number of resource blocks.

### BACKGROUND

To meet the demand for wireless data traffic having increased since deployment of 4^{th} generation (4G) communication systems, efforts have been made to develop an improved 5^{th} generation (5G) or pre-5G communication system. Therefore, the 5G or pre-5G communication system is also called a “beyond 4G network” or a “post long term evolution (LTE) System.”

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G communication systems.

In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

In the 5G system, hybrid frequency shift keying (FSK) and quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

### SUMMARY

To address the above-discussed deficiencies, it is a primary object to provide disclosure a method for selecting a modulation and coding scheme (MCS) and a number of resource blocks, comprising the following steps of: selecting, by a terminal, an MCS and the number of resource blocks for uplink data transmission according to power control information, channel state information, multiple access resource information, the size of a data packet and/or interference intensity information; and partitioning resource blocks within a frequency band according to a pre-defined resource partitioning and mapping pattern, and transmitting data through the partitioned resource block combination. Herein the partitioned resource block combination is corresponding to the selected MCS and the selected number of resource blocks.

An embodiment of the present disclosure further provides a method for determining an MCS and the number of resource blocks, comprising the following steps of: receiving, by a base station, data transmitted by a terminal apparatus through a multiple of resource block combinations; and determining an MCS corresponding to each resource block combination according to a pre-defined resource partitioning and mapping pattern, so as to determine an MCS and the number of resource blocks for uplink data transmission selected by the terminal.

An embodiment of the present disclosure further provides a resource configuration method, comprising the following steps of: allocating, by a base station, resource configuration information containing multiple access resources and demodulation reference signal (DMRS) resources for grant-free transmission of a multiple of terminal apparatuses; and transmitting corresponding resource configuration information to a multiple of terminals.

An embodiment of the present disclosure further provides a terminal for selecting an MCS and the number of resource blocks, comprising: at least one processor configured to select an MCS and the number of resource blocks for uplink data transmission according to power control information, channel state information, multiple access resource information, the size of a data packet and/or interference intensity information, and partition resource blocks within a frequency band according to a pre-defined resource partitioning and mapping pattern, and a transceiver configured to transmit data through the partitioned resource block combination. Herein, the partitioned resource block combination is corresponding to the selected MCS and the selected number of resource blocks.

An embodiment of the present disclosure further provides a base station for determining an MCS and the number of resource blocks, comprising: a transceiver configured to receive data transmitted by a terminal through a multiple of resource block combinations; and at least one processor configured to determine an MCS corresponding to each resource block combination according to a pre-defined resource partitioning and mapping pattern, so as to determine an MCS and the number of resource blocks for uplink data transmission selected by the terminal.

In the embodiments of the present disclosure, a base station quantifies interference intensity information, and then embeds the quantized interference intensity information into broadcast information or informs a terminal of the quantized interference intensity information by using a designed common control signaling and/or a high-layer signaling; and, according to the interference intensity information, channel state information obtained by a downlink reference signal, the transmitting power of each resource block determined in a power control mode configured by the high-layer signaling, and the size of a data packet, the terminal selects an MCS and the size of resource blocks by itself without scheduling of the base station. Meanwhile, by partitioning resources and establishing a mapping relation between resource block combinations and MCSs, the base station acquires the MCS used during transmission according to the resources used by the terminal, thereby avoiding blind detection, reducing complexity and improving link performance.

The above-mentioned solutions as provided in the present disclosure just make minor modification to the existing systems, and hence will not influence the system compatibility. Moreover, the implementations of these solutions as provided are both simple and highly efficient.

Additional aspects and advantages of the present disclosure will be partially appreciated and become apparent from the descriptions below, or will be well learned from the practice of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a schematic flow diagram of a method for selecting an MCS and the number of resource blocks by a terminal apparatus according to an embodiment of the present disclosure;

FIG. 2 illustrates a schematic flow diagram of selecting an MCS and the number of resource blocks by a terminal apparatus in a grant-free system according to an embodiment of the present disclosure;

FIG. 3 illustrates a schematic diagram of a basic flow of acquiring interference intensity information by a terminal according to an embodiment of the present disclosure;

FIG. 4 illustrates a schematic diagram of interference from neighboring cells according to an embodiment of the present disclosure;

FIG. 5 illustrates a structural diagram of uplink data and a reference signal according to an embodiment of the present disclosure;

FIG. 6 illustrates a schematic diagram of a quantization level and a decision threshold according to an embodiment of the present disclosure;

FIG. 7 illustrates a schematic diagram of broadcast information transmitted by a base station according to an embodiment of the present disclosure;

FIG. 8 illustrates a schematic diagram of a frequency hopping structure according to an embodiment of the present disclosure;

FIG. 9 illustrates a schematic diagram of a resource partitioning mode according to an embodiment of the present disclosure;

FIG. 10 illustrates a schematic mapping diagram of an MCS according to an embodiment of the present disclosure;

FIG. 11 illustrates a schematic mapping diagram according to an embodiment of the present disclosure;

FIG. 12 illustrates another schematic mapping diagram according to an embodiment of the present disclosure;

FIG. 13 illustrates yet another schematic mapping diagram according to an embodiment of the present disclosure;

FIG. 14 illustrates yet another schematic mapping diagram according to an embodiment of the present disclosure;

FIG. 15 illustrates yet another schematic mapping diagram according to an embodiment of the present disclosure;

FIG. 16 illustrates yet another schematic mapping diagram according to an embodiment of the present disclosure;

FIG. 17 illustrates yet another schematic mapping diagram according to an embodiment of the present disclosure;

FIG. 18 illustrates yet another schematic mapping diagram according to an embodiment of the present disclosure;

FIG. 19 illustrates a schematic flow diagram of a method for determining an MCS and the number of resource blocks by a base station apparatus according to an embodiment of the present disclosure;

FIG. 20 illustrates a structural diagram of a terminal apparatus for selecting an MCS and the number of resource blocks according to an embodiment of the present disclosure;

FIG. 21 illustrates a structural diagram of a base station apparatus for determining an MCS and the number of resource blocks according to an embodiment of the present disclosure;

FIG. 22 illustrates a configuration of a base station in a wireless communication system according to various embodiments of the present disclosure; and

FIG. 23 illustrates a configuration of a terminal in a wireless communication system according to various embodiments of the present disclosure.

### DETAILED DESCRIPTION

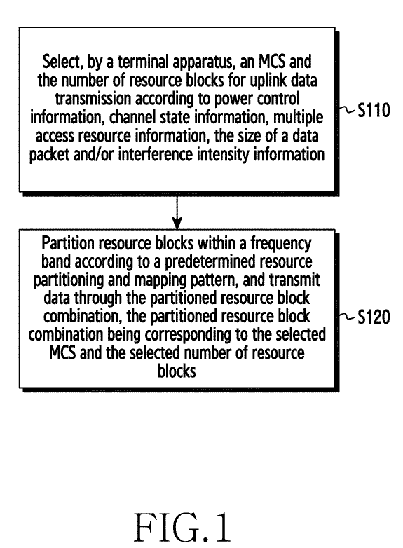

FIGS. 1 through 23, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The terms used in the present disclosure are only used to describe specific embodiments, and are not intended to limit the present disclosure. As used herein, singular forms may include plural forms as well unless the context clearly indicates otherwise. Unless defined otherwise, all terms used herein, including technical and scientific terms, have the same meanings as those commonly understood by a person skilled in the art to which the present disclosure pertains. Such terms as those defined in a generally used dictionary may be interpreted as having the meanings equal to the contextual meanings in the relevant field of art, and are not to be interpreted as having ideal or excessively formal meanings unless clearly defined in the present disclosure. In some cases, even terms defined in the present disclosure should not be interpreted as excluding embodiments of the present disclosure.

Hereinafter, various embodiments of the present disclosure will be described from the perspective of hardware. However, various embodiments of the present disclosure include a technology that uses both hardware and software, and thus the various embodiments of the present disclosure may not exclude the perspective of software.

According to the various embodiments of the present disclosure, method and apparatus for selecting and determining a modulation and coding scheme (MCS) is provided.

The rapid development of information industry, particularly the increasing demand from the mobile Internet and the Internet of Things (IoT), brings about unprecedented challenges in the future mobile communications technology. For example, according to the ITU-R M. issued by the International Telecommunication Union (ITU), it can be expected that, by 2020, mobile services traffic will grow nearly 1,000 times as compared with that in 2010 (4G era), and the number of user equipment (UE) connections will also be over 17 billion, and with a vast number of IoT equipments gradually expand into the mobile communication network, the number of connected equipments will be even more astonishing. In response to this unprecedented challenge, the communications industry and academia have prepared for 2020s by launching an extensive study of the fifth generation of mobile communications technology (5G). Currently, in ITU-R M. from ITU, the framework and overall objectives of 5G in the future have been discussed, where the demands outlook, application scenarios and various important performance indexes of 5G have been described in detail. In terms of new demands in 5G, the ITU-R M. from ITU provides information related to the 5G technology trends, which is intended to address prominent issues such as significant improvement on system throughput, consistency of the user experience, scalability so as to support IoT, delay, energy efficiency, cost, network flexibility, support for new services and flexible spectrum utilization, etc.

For more diverse business scenarios of 5G, the flexible multiple access technology is required to support various scenarios and business requirements. For example, for a business scenario with massive connections, how to allow more UEs to access in limited resources becomes a core problem to be solved in the 5G multiple access technology. In the present 4G LTE network, the orthogonal frequency division multiplexing (OFDM) based multiple access technologies are mainly employed, for example, downlink orthogonal frequency division multiple access (OFDMA) and uplink single-carrier frequency division multiple access (SC-FDMA). However, obviously, the existing access mode based on orthogonality cannot meet the requirements of 5G in improving the spectrum efficiency by 5 to 15 times and having millions of UEs accessed per square kilometer. The non-orthogonal multiple access (NMA) technology can greatly increase the connection number of supported UEs since the NMA technology shares the same resources to a multiple of UEs. Since there are more opportunities for UEs to access, the overall throughput of network and the spectrum efficiency are improved. In addition, for the massive machine type communication (mMTC) scenario, considering the cost of the terminal and the complexity in implementation, it may use more simply operated multiple access technologies. For business scenarios requiring low delay or low power consumption, the use of the non-orthogonal multiple access technology can better achieve grant-free and contention-based access and further low-delay communication, and can shorten the startup time and reduce the power consumption of the equipment.

The currently major non-orthogonal multiple access technologies in research are multiple user shared access (MUSA), non-orthogonal multiple access (NOMA), pattern division multiple access (PDMA), sparse code multiple access (SCMA) and interleave division multiple access (IDMA), etc. For MUSA, UEs are distinguished by code words; for SCMA, UEs are distinguished by a codebook; for NOMA, UEs are distinguished by power; for PDMA, UEs are distinguished by different feature patterns; and for IDMA, different UEs are distinguished by interleaver sequences. The uplink transmission of the current communication system is based on the scheduling of a base station apparatus. That is, the base station apparatus performs power control, selection of a modulation and coding scheme (MCS) and scheduling of time-frequency resources for each terminal through interference measurement and channel measurement, and informs the terminal of the results of selection and scheduling through a downlink signaling. For any one of the above novel multiple access technologies, during the grant-free transmission, there are two main problems in the prior art: first, without scheduling of a base station apparatus, how a terminal performs power control, selection of an MCS and selection of the number of time-frequency resources to perform uplink data transmission; and second, how a terminal informs the base station apparatus of the result of the selection after selecting the MCS and the time-frequency resources for transmission.

Regarding the above-mentioned two problems, there is no clear solution currently in the prior art. Majority of academic and industrial researches focus on an assumption that a base station apparatus does not know an MCS and the number of resource blocks in advance and thus performs demodulation by blind detection. That is, the use conditions of all possible MCSs and the number of resource blocks are traversed, and it is determined whether the demodulation is performed correctly according to cyclic check bits. In the novel multiple address technologies, since a large number of users are superposed and the size of data packets transmitted by the users can be different, the MCS and the number of used resource blocks can also be different, so that the complexity of blind detection will be increased greatly. Consequently, a large demodulation time delay is caused. Moreover, the reliability of links is reduced greatly, more retransmission feedbacks are caused, and the throughput is reduced.

The present disclosure provides a method for selecting an MCS and the number of resource blocks by a terminal apparatus in a grant-free system, and informs a base station of the MCS used by the terminal apparatus during transmitting data by a resource portioning and mapping method, so that the blind detection is avoided and the link performance is improved. To realize the above-mentioned purpose, the present application employs the following technical solutions. The specific flow is shown in FIG. 1 and can comprise the following steps.

S110: By a terminal apparatus, an MCS and the number of resource blocks for uplink data transmission are selected according to power control information; channel state information, multiple access resource information, the size of a data packet and/or interference intensity information.

S120: Resource blocks within a frequency band are partitioned according to a pre-defined resource partitioning and mapping pattern, and data are transmitted through the partitioned resource block combination, and the partitioned resource block combination being corresponding to the selected MCS and the selected number of resource blocks.

Specifically, step S110 comprises steps S111, S112, S113 and S114.

S111: A transmitting power of each resource block is determined according to the power control information.

S112: A signal-to-interference-plus-noise ratio (SINK) is determined according to the determined transmission power of each resource block by calculation and in combination with the multiple access resource information, the channel state information and/or the interference intensity information, so as to determine an MCS.

S113: The number of resource blocks to be selected is determined according to the transmission power of each resource block and in accordance with a pre-defined maximum power limit.

S114: The MCS to be selected and/or the number of resource blocks to be selected are adjusted according to the size of a data packet so as to determine the MCS and the number of resource blocks for uplink data transmission.

More specifically, an MCS to be selected and the number of resource blocks to be selected are determined as the MCS and the number of resource blocks for uplink data transmission, if the number of data blocks corresponding to the MCS to be selected and the number of resource blocks to be selected is less than or equal to the size of the data packet; and an MCS and the number of resource blocks, corresponding to a minimum data block greater than the size of the data packet, are selected as the MCS and the number of resource blocks for uplink data transmission, by decreasing the number of resource blocks and/or lowering MCS level, if the number of data blocks corresponding to the MCS to be selected and the number of resource blocks to be selected is greater than the size of the data packet.

Preferably, the way of determining the transmitting power of each resource block includes: determining a power control mode according to a high-layer signaling from a base station apparatus; and determining a transmitting power of each resource block according to the power control mode.

Wherein, the power control mode includes at least one of open-loop power control based on full compensation path loss, open-loop power control based on different path loss compensations, and closed-loop power control.

Preferably, if the power control mode is the open-loop power control based on different path loss compensations or the closed-loop power control, the transmitting power of each resource block is adjusted based on the MCS to be selected.

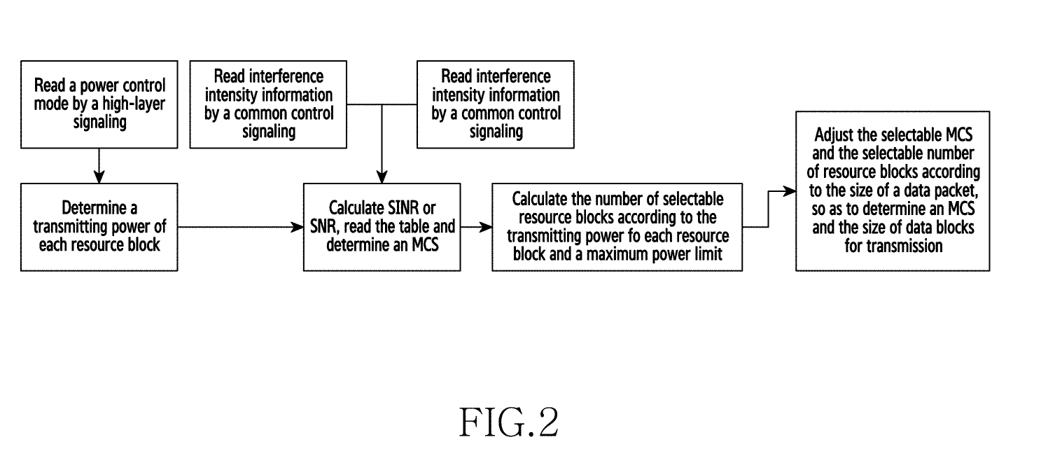

In some embodiments, when an MCS and the number of resource blocks are selected, it is required to consider various factors, such as a transmitting power of each resource block, the size of a data packet, channel state information, multiple access resource information and/or interference intensity information. The operation flow provided by this embodiment is as shown in FIG. 2.

First step: A power control mode is determined by a terminal apparatus according to the configuration of a high-layer signaling from a base station apparatus. The power control mode includes the following three modes.

The first mode is open-loop power control based on full compensation path loss. In this mode, a base station allocates a same power reference to terminals through a high-layer signaling and informs the terminal of full compensation path loss. That is, the path loss compensation factor is set as α=1. Thus, the calculation formula of the transmitting power of a terminal k is calculated by:

Pₖ=P₀+PLₖ,

where PLₖ is the path loss of the terminal k. By using this power control mode, a receiving power of a signal transmitted by each terminal to the base station is nearly the same.

The second mode is open-loop power control based on different path loss compensations. Compared with the first mode, in this mode, a base station allocates different power references and path loss compensation factors to terminals through a high-layer signaling. Meanwhile, terminals are allowed to adjust the transmitting power according to the selected MCS so as to realize certain link performance. Thus, the calculation formula of the transmitting power of a terminal k is calculated by:

Pₖ=P_{0,k}+αₖ×PLₖ+Δₖ,

where PLₖ is the path loss of a terminal k, P_{0,k} is a power reference allocated to a terminal k, αₖ is a path loss compensation factor of a terminal k, and Δₖ is power adjustment performed according to the MCS. Compared with the first mode, this mode can allow the receiving power of signals transmitted by different terminals to the base station to be different, being particularly applicable to a receiver algorithm depending on interference elimination.

The third mode is closed-loop power control. Based on the second mode, in this mode, a power control command for terminals can be transmitted. Thus, the calculation formula of the transmitting power of a terminal k is calculated by:

Pₖ=P_{0,k}+αₖ×PLₖ+Δₖ+f(Δ_{TPC,k}),

where f(Δ_{TPC,k}) is a power control command for a terminal k. Compared with the second mode, this mode not only can realize a different receiving power for different terminals, but also can more precisely perform power control, for example, compensating the influence of small-scale fading on the receiving power.

Note that the mathematical expressions for power calculation are based on a log domain, i.e., in unit of dBm.

Second step: By a terminal, an SINR is calculated according to the transmitting power of each resource block calculated in the first step and in combination with the interference intensity information acquired from a common signaling and the channel state information obtained by downlink reference signal detection, and an MCS to be selected for uplink data transmission is obtained by table lookup.

It is to be noted that, without interference information of neighboring cells informed by the common signaling, this embodiment can calculate the SNR according to the channel state information and the transmitting power of each resource block so as to select an MCS and the number of resource blocks.

Wherein, for the open-loop power control based on different path loss compensations and the closed-loop power control, a power offset Δₖ corresponding to the selected MCS is obtained, and the power of each resource block is recalculated.

Third step: By the terminal, the maximum number of available resource blocks is calculated according to the power of each resource block and in accordance with a maximum power limit, as the number of block resources to be selected.

Specifically, the maximum power limit is denoted by Pₘₐₓ, and then the number of resource blocks to be selected is:

$$M = ⌊ {10}^{\frac{{P}_{ma x} - {P}_{k}}{10}} ⌋ ,$$

where [a] is a greatest integer no more than a. At Pₘₐₓ=24 dBm and Pₖ=16 dBm, the number of resource blocks that can be supported is M=6.

Fourth step: The number of resource blocks to be selected and/or the MCS to be selected are/is adjusted according to the size of a data packet of the terminal.

Specifically:

Adjustment of the number of resource blocks: if the number of data blocks, corresponding to the number of selectable resource blocks obtained in the third step, is less than or equal to the size of the data packet of the terminal, transmission is performed by using the number of resource blocks; otherwise, if the number of data blocks corresponding to the number of selectable resource blocks is greater than the size of the data packet of the terminal, the number of resource blocks corresponding to a minimum data block greater than the size of the data packet of the terminal is selected.

TABLE 1
Schematic mapping table of MCSs, the size of
data blocks, and the size of resource blocks

| | | | 2 resource | 4 resource | 6 resource |
|---|---|---|---|---|---|
| I_MCS | Q | I_TBS | blocks | blocks | blocks |
| 0 | 2 | 0 | 12 bits | 48 bits | 84 bits |
| 1 | 2 | 1 | 48 bits | 72 bits | 120 bits |
| 2 | 2 | 2 | 72 bits | 120 bits | 192 bits |

As shown in Table 1, the number of resource blocks available for data transmission is 2, 4, 6, and each resource block corresponds to three available sizes of data blocks. It is assumed that I_MCS=1 is determined by the calculation in the second step, and the number of resource blocks to be selected is determined in the third step to be 4. In accordance with Table 1, if the size of the data packet of the terminal is 100 bits, the used data blocks is 72; and, if the size of the data packet of the terminal is 8 bits, two resource blocks are used and the size of data blocks is still 12 after the number of resource blocks is adjusted.

Adjustment of the MCS: if the number of data blocks, corresponding to the selectable MCS obtained in the third step, is less than or equal to the size of the data packet of the terminal, transmission is performed by using the MCS; otherwise, the number of data blocks corresponding to the selectable MCS is greater than the size of the data packet of the terminal, an MCS corresponding to a minimum data block greater than the size of the data packet of the terminal is selected.

It is assumed that I_MCS=1 is determined by the calculation in the second step, and the maximum number of available resource blocks obtained in the third step to be 6. In accordance with Table 1, if the size of the data packet of the terminal is 140 bits, the used data blocks is 120; and, if the size of the data packet of the terminal is 80 bits, I_MCS=0 is used and the size of data blocks is still 84 after the MCS is adjusted.

Adjustment of the size of resource blocks and the MCS: if the number of data blocks, corresponding to the MCS and the size of resource blocks selected in the third step and the second step, is less or equal to the size of the data packet, transmission is performed by using this MCS and the size of resource blocks; otherwise, an MCS and the number of resource blocks corresponding to a minimum data block greater than the size of the data packet of the terminal are selected.

It is assumed that I_MCS=2 is calculated in the second step, and the maximum number of available resource blocks in the third step is 4. Then, in accordance with Table 1, if the size of the data packet of the terminal is 40 bits, then I_MCS=1 is used, the size of resource blocks is 2, and the size of data blocks is still 48.

It is to be noted that, the way of acquiring interference intensity information by a terminal apparatus comprises: acquiring the interference intensity information by receiving broadcast information or a common control signaling and/or the high-layer signaling for the interference feedback from the base station apparatus, the interference intensity information being obtained by performing interference measurement on time-frequency resources for a grant-free system by the base station apparatus.

If there is a reference signal in the frequency band of the grant-free system, the interference intensity information is obtained by performing channel estimation and subtracting the result of the channel estimation from a received signal by the base station apparatus; and if there is no reference signal and data transmission in the frequency band of the grant-free system, the interference intensity information is obtained according to an intensity measurement performed on the received signal by the base station apparatus.

Wherein, the interference intensity information is obtained by quantizing the interference intensity according to a maximum interference intensity and a minimum interference intensity determined according to the radius of this cell and the radius of a neighboring cell.

It is to be noted that, a base station performs interference measurement on a frequency band for grant-free transmission to determine interference intensity information, and then transmits the interference intensity information through broadcast information or a common control signaling for the interference feedback.

Specifically, if there is a reference signal in the frequency band of the grant-free system, a base station determines the interference intensity information by performing channel estimation and subtracting the result of the channel estimation from a received signal; and if there is no reference signal and data transmission in the frequency band of the grant-free system, the base station determines the interference intensity information according to an intensity measurement performed on the received signal.

Wherein, if the total power of the received signal is greater than a pre-defined threshold, it is determined that there is a reference signal in the frequency band of the grant-free system; and if the total power of the received signal is less than the pre-defined threshold, it is determined that there is no reference signal and data transmission in the frequency band of the grant-free system.

Preferably, a maximum interference intensity and a minimum interference intensity are determined according to the radius of this cell and the radius of a neighboring cell; and the interference intensity is quantized according to the maximum interference intensity and the minimum interference intensity to obtain the interference intensity information.

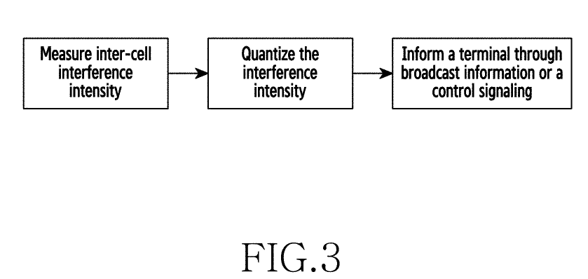

FIG. 3 illustrates a schematic diagram of a basic flow of acquiring the interference intensity information by a terminal, specifically comprising the following steps.

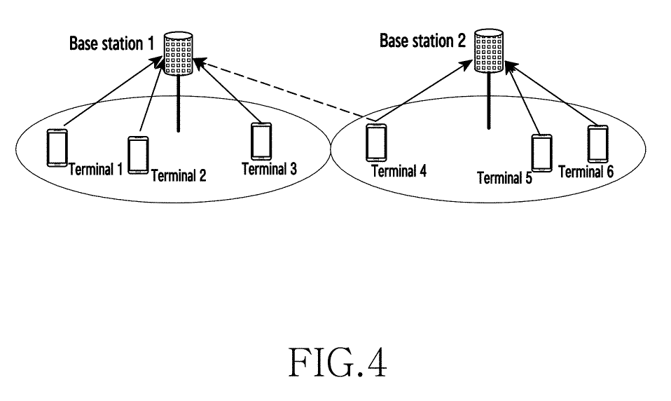

Step 1: An interference measurement is performed on time-frequency resources for a grant-free system by a base station. In this embodiment, the interference is mainly from edge terminal apparatuses of adjacent cells, for example, interference from a terminal 4 to a base station 1 in FIG. 4. It is to be noted that, in this embodiment, two adjacent cells can be cells controlled by different base stations, or can be cells controlled by a same base station. In both cases, the processing mode of specific resource allocation is the same. Specifically, two measurement modes are included.

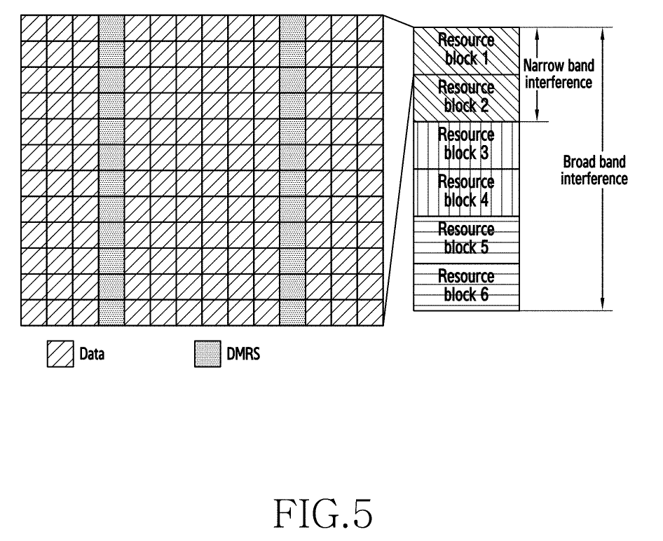

First mode: this mode is suitable for a case where there is a reference signal and data transmission in the frequency band of the grant-free system specifically, a case where there is a reference signal and data in a subframe as shown in FIG. 5. In FIG. 5, the received signal comprises uplink data, a reference signal and data transmission, i.e., a DMRS.

Specifically, the signal received by the base station consists of superposing a reference signal, inter-cell interference and thermal noise. First, the base station performs channel estimation by using the reference signal and then subtracts the portion of the reference signal from the received signal according to the obtained result of the channel estimation, so that the remaining portion contains interference and noise. It is to be noted that, the interference in this embodiment includes channel estimation deviation and inter-cell interference. Then, the base station measures the energy of the remaining portion and uses the result of measurement as the interference intensity.

Second mode: this method is suitable for a case where there is no reference signal and data transmission in the frequency band of the grant-free system, specifically, a case where there is no reference signal and data in the subframe.

Specifically, the signal received by the base station is constituted by superposing inter-cell interference and thermal noise. The base station directly measures the energy of the received signal and uses the result of measurement as the interference intensity.

It is to be noted that, since the above-mentioned measurement process is performed for the grant-free system, the base station is unable to know whether the reference signal and data are contained in the current subframe in advance. To distinguish application scenarios of the two modes, a measurement threshold can be set. That is, if the total power of the received signal is greater than the pre-defined threshold, it is determined that a reference signal and data are contained in the received signal, and the interference measurement is performed in the first mode; and if the total power of the received signal is less than the pre-defined threshold, it is determined there are only interference and noise in the received signal, and the interference measurement is performed in the second mode.

Further, the interference measurement can be in units of narrow bands, or can be in units of broad bands. As shown in FIG. 4, by summing and averaging the interference intensities of each subcarrier within every two resource blocks, the interference intensity of narrow bands can be determined. Then, by summing and averaging the interference intensities of each of narrow bands, the interference intensity of broad bands can be determined. It is to be noted that, in this embodiment, the broad bands are defined as the bandwidth of transmission frequency bands of the whole grant-free system, and the bandwidth of the narrow bands is an integral multiple of the resource blocks. In addition, each of the narrow bands can be superposed, and the bandwidth and location of each narrow band are determined according to the system resource configuration.

Furthermore, since the base station feeds back the interference intensity to the terminal periodically, it is only required to measure the interference intensity of one or more subframes before the interference intensity is fed back, calculate an average, and use the result as the interference intensity of broad bands and narrow bands to be quantized.

Step 2: The interference intensity is quantized.

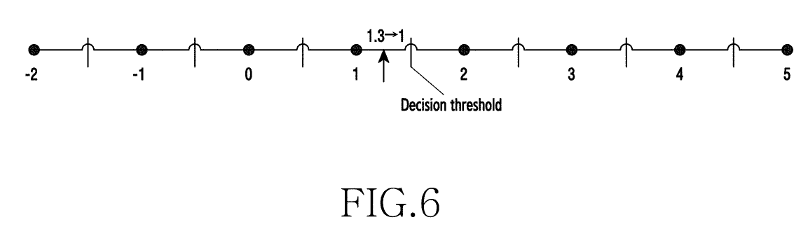

FIG. 6 depicts a 3-bit quantization method, where there are totally 8 quantization levels, i.e., −2 dB, −1 dB, 0 dB, 1 dB, 2 dB, 3 dB, 4 dB and 5 dB, which correspond to bits 000, 001, 010, 011, 100, 101, 110 and 111, respectively.

A specific decision method is illustrated in Table 2. As shown in FIG. 6, if the interference level is 1.3 dB, the corresponding quantization level is 1 dB.

TABLE 2
Quantization and decision schemes

| Actual interference level (dB) | Quantization level (dB) | Bit |
|---|---|---|
| (−∞, −1.5] | −2 | 000 |
| (−1.5, −0.5] | −1 | 001 |
| (−0.5, 0.5] | 0 | 010 |
| (0.5, 1.5] | 1 | 011 |
| (1.5, 2.5] | 2 | 100 |
| (2.5, 3.5] | 3 | 101 |
| (3.5, 4.5] | 4 | 110 |
| (4.5, ∞) | 5 | 111 |

The quantization method is suitable for narrow band interference measurement and broadband interference measurement. In addition, an upper limit and a lower limit of a quantization level are determined by possible maximum and minimum interferences in the system, respectively, so that a controllable quantization error is ensured, that is, the quantization error mainly depends on a quantization interval and the number of quantization levels. It is to be noted that both the radius of this cell and the radius of a neighboring cell will influence the interference intensity. Therefore, the maximum interference intensity needs to be determined by measuring the interference if both a neighboring cell and this cell are cells having the minimum radius, while the minimum interference intensity needs to be determined by measuring the interference if both the neighboring cell and this cell are cells having the maximum radius.

Step 3: The quantized broad band interference intensity and the quantized narrow band interference intensity are transmitted by the base station to a terminal through a downlink common signaling.

Here, the number of bits used for the quantization is denoted by B and the total number of narrow bands in the frequency band is denoted by N, so the total number of bits to be transmitted is B×(N+1). Wherein, the first B bits represent the interference intensity of broad bands, and the (n×B+1)^{th} bit to the (B×(n+1))^{th} bit represent the interference intensity of the n^{th} narrow band, where n=1, 2, . . . N. In addition, there are following two kinds of used common signaling.

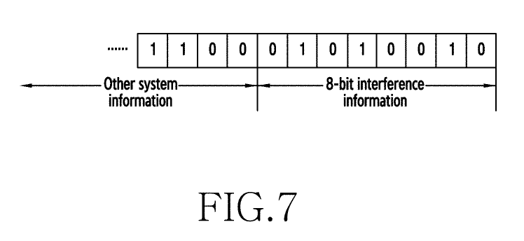

The first mode is informing the terminal through broadcast information. Specifically, in an LTE system, the base station transmits broadcast information per 40 ms. When transmitting the interference intensity; the base station embeds B×(N+1) bits into the end of the system information. As shown in FIG. 7, in a case where there are 2-bit quantization and three narrow band interference feedbacks and one broad band interference feedback, the total 8 bits are embedded into the end of other system information. Thus, the terminal reads the data in the least broadcast information after receiving, to acquire information about the interference intensity of the neighboring cell.

The second mode is designing a special common control signaling for interference feedback. Specifically, in an LTE system, the base station transmits the common control signaling per 10 ms. It is to be noted that, in this embodiment, it is required to design a new wireless network temporary identifier for scrambling a check bit of the common control singling so as to distinguish from other common control signaling. Thus, the terminal reads the data in the least common control signaling after receiving, to acquire information about the interference intensity of the neighboring cell.

It is to be noted that, although the broadcast information and the common control signaling are transmitted periodically, where there may be various kinds of common control signaling in the system, the terminal detects the common control signaling every 10 ms, and the base station selects to transmit what kind of common control signaling every 10 ms. However, according to the conditions of a specific application scenario, the base station can embed interference information into the broadcast information non-periodically, or can transmit the common control signaling for interference feedback as described in this embodiment non-periodically. For example, if the interference level in the system is low, the base station can select not to transmit the common control signaling for interference feedback. The terminal blindly detects the common control signaling per 10 ms. If no common control signaling for interference feedback is detected, it is considered that the interference information is not transmitted.

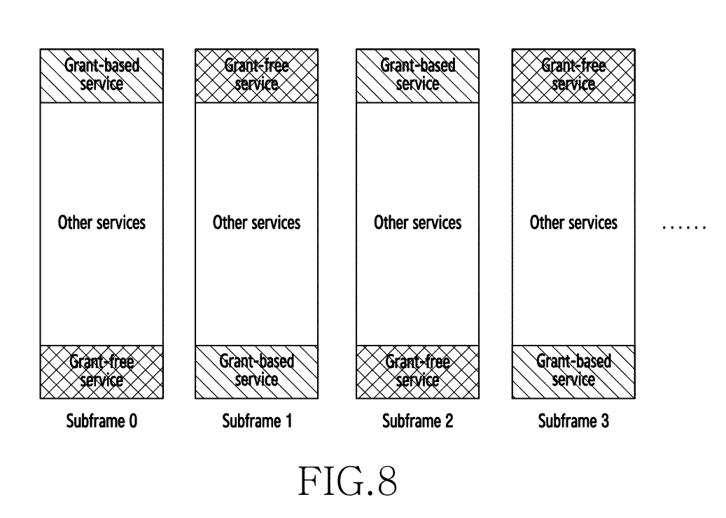

Further, the frequency band for the grant-free system in this embodiment includes the case of symmetrical frequency hopping as shown in FIG. 8. Specifically, a frequency band based on scheduled transmission and a frequency band based on grant-free transmission are located at two ends of one section of spectrum resource, respectively. In the next subframe, the locations of the frequency band based on scheduled transmission and the locations of the frequency band based on the grant-free transmission are interchanged. Taking FIG. 8 as example, in an even subframe, the frequency band based on scheduled transmission is located at the uppermost end of the spectrum, while the frequency band based on grant-free transmission is located at the lowermost end of the spectrum; however, in an odd subframe, the frequency band based on scheduled transmission is located at the lowermost end of the spectrum, while the frequency band based on grant-free transmission is located at the uppermost end of the spectrum. In this case, it is required to measure, quantify and feed back the interference intensity of the two frequency bands.

As shown in FIG. 1, S120: resource blocks within a frequency band are partitioned according to a pre-defined resource partitioning and mapping pattern, and data are transmitted through the partitioned resource block combination, the partitioned resource block combination corresponds to the selected MCS and the selected number of resource blocks.

Specifically, a resource partitioning and mapping pattern is determined by receiving the common control signaling and/or high-layer signaling from the base station apparatus, the common control signaling and/or high-layer signaling comprising an application scenario number corresponding to the resource partitioning and mapping pattern.

Wherein, the resource partitioning and mapping pattern comprises at least one of the following resource partitioning modes: partitioning the resource blocks within the frequency band into resource block combinations of the same size; and partitioning the resource blocks within the frequency band into resource block combinations of different sizes.

Specifically, different subframes can employ different resource partitioning modes, and the resource partitioning mode can occur periodically or non-periodically, and the MCS can also occur periodically or non-periodically.

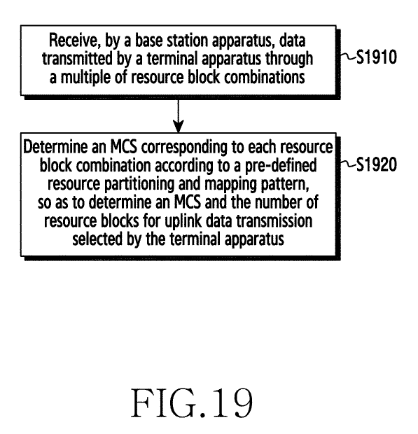

The present disclosure further provides a method for determining an MCS and the number of resource blocks. As shown in FIG. 19, the specific flow can comprise the following steps.

S1910: By a base station apparatus, data transmitted by a terminal apparatus is received through a multiple of resource block combinations.

S1920: An MCS corresponding to each resource block combination is determined according to a pre-defined resource partitioning and mapping pattern, so as to determine an MCS and the number of resource blocks for uplink data transmission selected by the terminal apparatus.

Preferably, by the base station, the pre-defined resource partitioning and mapping pattern is transmitted through a common control signaling and/or a high-layer signaling, the common control signaling and/or the high-layer signaling including an application scenario number corresponding to the resource partitioning and mapping pattern.

In some embodiments of a grant-free system, if a terminal needs to transmit data, an MCS and the number of resource blocks are selected through the modes of the aforementioned embodiments. At this time, since a base station does not know the MCS and the number of resource blocks used by the terminal, the existing solution is to perform blind detection on all possible MCSs. However, in a novel multiple access system, since a large number of user data is superposed and the MCS used by the data of each user can be different, the blind detection is highly complex; furthermore, if the data of different MCSs is superposed, the performance of joint detection will be influenced. Hence, this embodiment describes a mapping pattern between MCSs and resource blocks, whereby the data of different modulation modes is orthogonal on time-frequency resources and the data of the same MCSs use the same time-frequency resource blocks. Meanwhile, without additional signaling overheads, a base station can acquire an MCS according to the use condition of resource blocks, so that the blind detection is avoided. The specific implementation will be described below.

In an actual communication system, the MCS (I_MCS) consists of the size of a data block (I_TBS) and the modulation order (Q), where the size of a data block changes according to the size of allocated resource blocks. Table 2 depicts an example of three MCSs. If transmission is performed by using 2 resource blocks, the size of data blocks corresponding to the three MCSs is 12 bits, 48 bits, 72 bits, respectively; if transmission is performed by using 4 resource blocks, the size of data blocks corresponding to the three MCSs is 48 bits, 72 bits and 120 bits, respectively; and if transmission is performed by using 6 resource blocks, the size of data blocks corresponding the three MCSs is 84 bits, 120 bits and 192 bits, respectively.

To acquire the mapping relation between MCSs and resources, it is required to partition resources within a frequency band of the grant-free system according to the size of resource blocks and then allocate MCSs for the partitioned resources.

Specifically, the resource partitioning can have two modes.

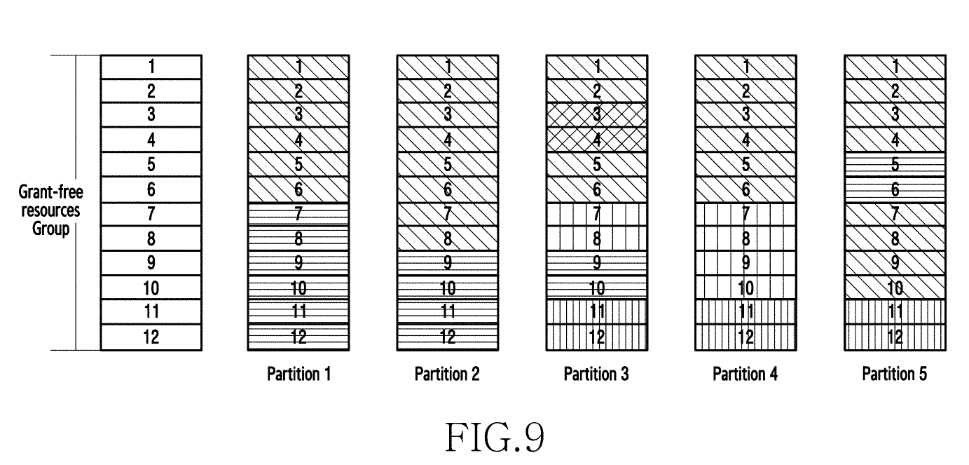

The first mode is partitioning the frequency band of the grant-free system within each subframe into narrow bands of the same size. As shown in FIG. 9, there are 12 resource blocks for grant-free transmission within each subframe. In accordance with the size of available resource blocks shown in Table 2, there are three results of partitioning, i.e., partition 1 including two groups each having 6 resource blocks, partition 2 including three groups each having 4 resource blocks, and partition 3 including six groups each having 2 resource blocks.

The second mode is partitioning resource blocks within each subframe into narrow bands of different sizes. FIG. 9 shows partition 4 and partition 5. That is, 12 resource blocks for grant-free transmission in each subframe can be partitioned into three groups, among which the first group has 6 resource blocks, the second group has 4 resources and the third group has 2 resources. The 12 resource blocks can also be partitioned into four groups, among which two groups each have 4 resource blocks while the other two groups each have 2 resource blocks. It is to be noted that the second partitioning mode also has other possible partitioning conditions and the arrangement sequence of narrow bands of different sizes can be exchanged. It is to be noted that the narrow band interference measurement and feedback in the aforementioned embodiment can be performed according to the result of the resource partitioning in this embodiment.

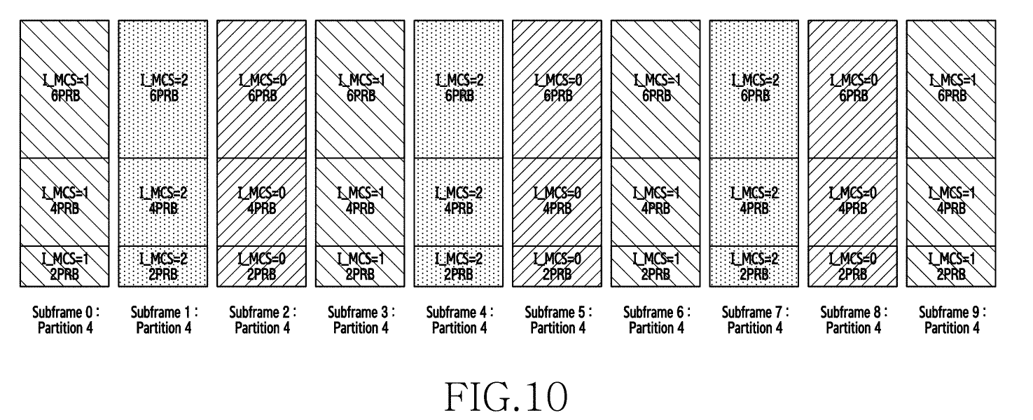

Then, specified MCSs are allocated to the partitioned resource blocks, and the base station can acquire a corresponding MCS according to a subframe number and the resource partitioning mode. As shown in FIG. 10, if all 10 subframes in a frame employ partition 4, the mapping relation between resource blocks in each subframe and MCSs can be expressed by:

I_MCS=(n+1)mod 3, n=0,1,2,3,4,5,6,7,8,9.

If the terminal needs to transmit data, interference intensity information is acquired according to the mode in the aforementioned embodiment, then an MCS is selected according to the mode in the aforementioned embodiment, and corresponding resource blocks are selected according to the mapping pattern in this embodiment for transmission. In accordance with the mapping relation, the base station acquires the MCS corresponding to each resource block, so that the blind detection is avoided and the reliability of links is improved.

It is to be noted that, this embodiment is described only in a case where subframes employ the same partitioning mode. In practice, each subframe can employ different partitioning modes, and the mapping pattern of specific MCSs can also be different from the mathematical expression in this embodiment. In this case, the implementation of this embodiment will not be influenced.

It is to be noted that the locations of the 12 resource blocks for grant-free transmission in this embodiment can change according to the different serial numbers of subframes, for example, in the case of frequency hopping shown in FIG. 7. The number of resource blocks for grant-free transmission in the system can also be other values, such as 4, 6 or 8, but the implementation of this embodiment will not be influenced in this case.

The modulation and coding mapping pattern in the above-mentioned example occurs periodically and cyclically. Further, the frequency of occurrence of any one MCS in a frequency domain or a time domain can be changed by configuring a common signaling. Specifically, the frequency of occurrence of each resource block combination can be changed by introducing different partitioning, or the frequency of occurrence of each MCS can be changed by changing the modulation and coding mapping pattern. For example, if there are many data transmitted by a terminal or many terminals accessed simultaneously, partition 1 can be allocated preferably; otherwise, partition 3 and partition 5 will be allocated preferably. For another example, in a case where the use rate of the 6-resource-block combinations is reduced due to the limited power of a terminal, partition 2 and partition 5 can be allocated preferably. For yet another example, if the error probability increases since many terminals are accessed in the system, a low-rate MCS can be allocated preferably, for example, I_MCS=0 and I_MCS=1, so that the link performance is improved.

If the resource partitioning mode and the modulation and coding mapping pattern are configured through a common signaling, a large number of common signaling overheads will be caused since there are many types of partitioning and each resource block combination can correspond to many kinds of MCSs. Therefore, to realize the configuration of the resource partitioning and the modulation and coding mapping, several application scenarios can be set in advance, and then corresponding resource partitioning and modulation and coding mapping schemes are designed for different application scenarios. This case will be described hereinafter.

TABLE 3
Predefined scenarios

| | High rate | Medium rate | Low rate |
|---|---|---|---|
| High data | Scenario 1 (000) | Scenario 2 (001) | Scenario 3 (010) |
| volume | | | |
| Medium data | Scenario 4 (011) | Scenario 5 (default) | Scenario 6 (100) |
| volume | | | |
| Low data | Scenario 7 (101) | Scenario 8 (110) | Scenario 9 (111) |
| volume | | | |

Scenario 1: For a high-data-volume scenario, it may be considered that subframes 0, 3, 6 and 9 employ partition 1, while the remaining subframes employ partition 4. Therefore, there are fourteen 6-resource-block combinations, six 4-resource-block combinations and six 2-resource-block combinations in one frame. For a high-rate scenario, among the 6-resource-block combinations, the number ratio of three MCSs is as follows: I_MCS0:I_MCS1:I_MCS2=1:2:4; while among the 4-resource-block combinations and the 2-resource-block combinations, the number ratio of three MCSs is as follows: I_MCS0:I_MCS1:I_MCS2=1:2:3. The rules of mapping between the serial numbers of subframes and the MCSs are as follows: (1) for the 6-resource-block combinations, I_MCS=2−(n mod 3), n<=4; and I_MCS=(2+n) mod 3, n>=5; (2) for the 2-resource-block combinations and the 4-resource-block combinations, I_MCS=(9−n) mod 3, n=1, 2, 4, 7, 8; and I_MCS=0, n=5.

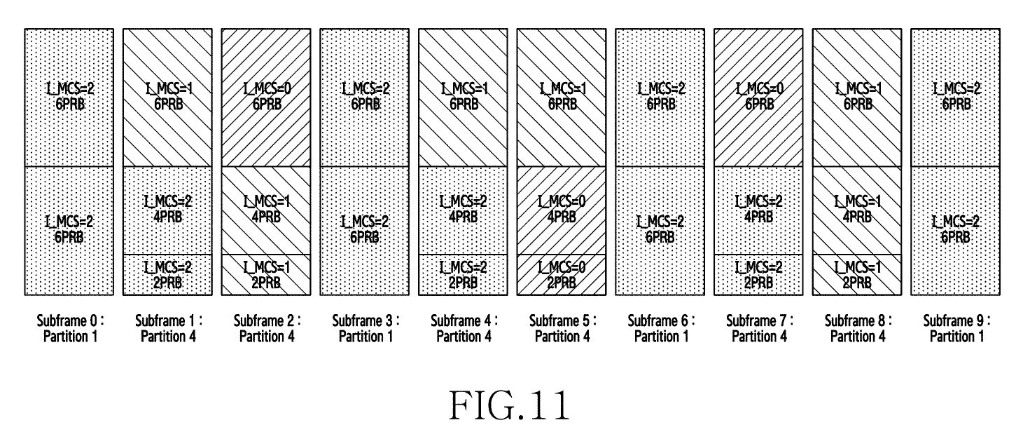

The specific mapping schemes are as shown in FIG. 11.

Scenario 2: For a high-data-volume scenario, it may be considered that subframes 0, 3, 6 and 9 employ partition 1, while the remaining subframes employ partition 4. Therefore, there are fourteen 6-resource-block combinations, six 4-resource-block combinations and six 2-resource-block combinations in one frame. For a medium-rate scenario, among the 6-resource-block combinations, the number ratio of three MCSs is as follows: I_MCS0:I_MCS1:I_MCS2=2:3:2; while among the 4-resource-block combinations and the 2-resource-block combinations, the number ratio of three MCSs is as follows: I_MCS0:I_MCS1:I_MCS2=1:1:1. For the 6-resource-block combinations: I_MCS=2*(n/3 mod 2), n=0, 3, 6, 9; and I_MCS=1, n=1, 2, 4, 5, 7, 8. For the 2-resource-block combinations and the 4-resource-block combinations: I_MCS=log 2(n), n=1, 2, 4; and I_MCS=2−log 2(9−n), n=5, 7, 8.

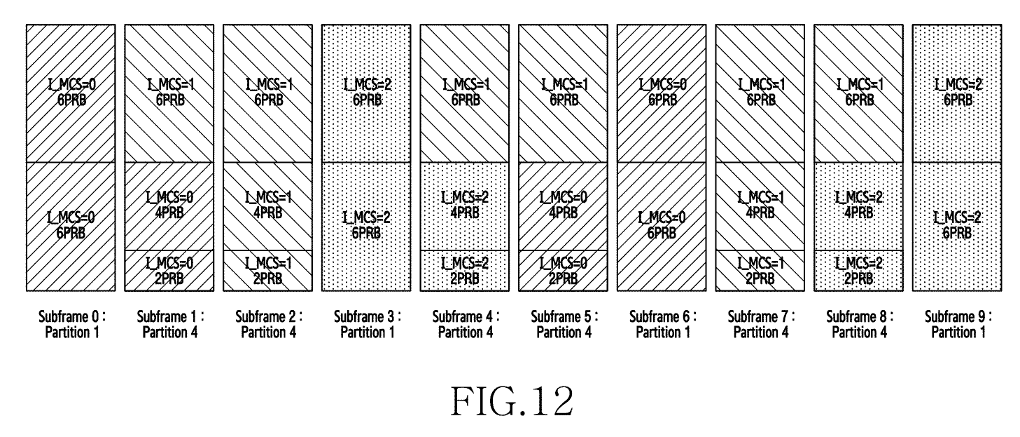

The specific mapping schemes are as shown in FIG. 12.

Scenario 3: For a high-data-volume scenario, it may be considered that subframes 0, 3, 6 and 9 employ partition 1, while the remaining subframes employ partition 4. Therefore, there are fourteen 6-resource-block combinations, six 4-resource-block combinations and six 2-resource-block combinations in one frame. For a low-rate scenario, among the 6-resource-block combinations, the number ratio of three MCSs is as follows: I_MCS0:I_MCS1:I_MCS2=4:2:1; while among the 4-resource-block combinations and the 2-resource-block combinations, the number ratio of three MCSs is as follows: I_MCS0:I_MCS1:I_MCS2=3:2:1.

For the 6-resource-block combinations: I_MCS=n mod 3, n=0, 1, 2, 3, 4; and I_MCS=(9−n) mod 3, n=5, 6, 7, 8, 9.

For the 2-resource-block combinations and the 4-resource-block combinations: I_MCS=(n mod 3)−1, n=1, 2, 4, 7, 8; and I_MCS=2, n=5.

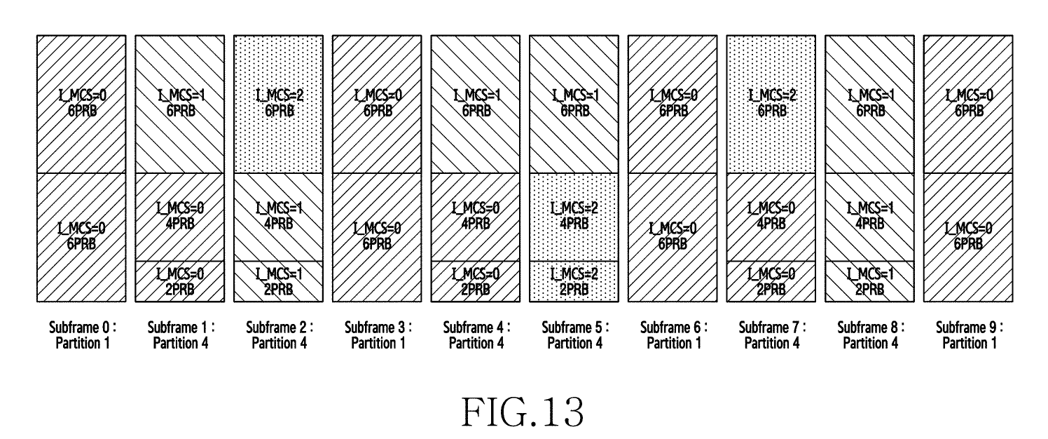

The specific mapping schemes are as shown in FIG. 13.

Scenario 4: For a medium-data-volume scenario, it may be considered that each subframe employs partition 4. Therefore, there are ten 6-resource-block combinations, ten 4-resource-block combinations and ten 2-resource-block combinations in one frame. For a high-rate scenario, the number ratio of three MCSs is as follows: I_MCS0:I_MCS1:I_MCS2=2:3:5.

For the 2-resource-block combinations, the 4-resource-block combinations and the 6-resource-block combinations: I_MCS=2, n=0, 2, 4, 6, 8; I_MCS=1, n=1, 5, 9; and I_MCS=2, n=3, 7.

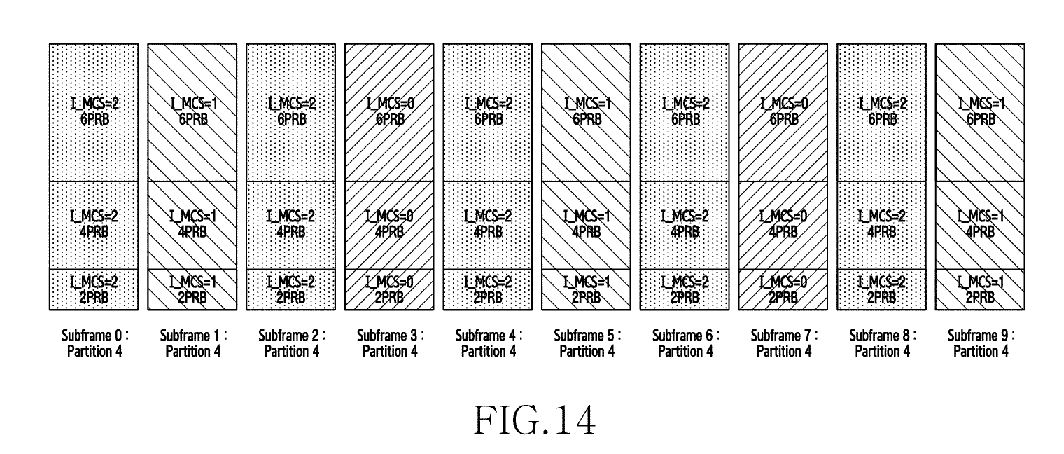

The specific mapping schemes are as shown in FIG. 14.

Scenario 5: For a medium-data-volume scenario, it may be considered that each subframe employs partition 4. Therefore, there are ten 6-resource-block combinations, ten 4-resource-block combinations and ten 2-resource-block combinations in one frame. For a medium-rate scenario, the number ratio of three MCSs is as follows: I_MCS0:I_MCS1:I_MCS2=3:4:3.

For the 2-resource-block combinations, the 4-resource-block combinations and the 6-resource-block combinations: I_MCS=(n+1) mod 3, n=0, 1, 2, 3, 4, 5, 6, 7, 8, 9.

The specific mapping schemes are as shown in FIG. 10.

Scenario 6: For a medium-data-volume scenario, it may be considered that each subframe employs partition 4. Therefore, there are ten 6-resource-block combinations, ten 4-resource-block combinations and ten 2-resource-block combinations in one frame. For a low-rate scenario, the number ratio of three MCSs is as follows: I_MCS0:I_MCS1:I_MCS2=5:3:2.

For the 2-resource-block combinations, the 4-resource-block combinations and the 6-resource-block combinations: I_MCS=0, n=0, 2, 4, 6, 8; I_MCS=1, n=1, 5, 9; and I_MCS=2, n=3, 7.

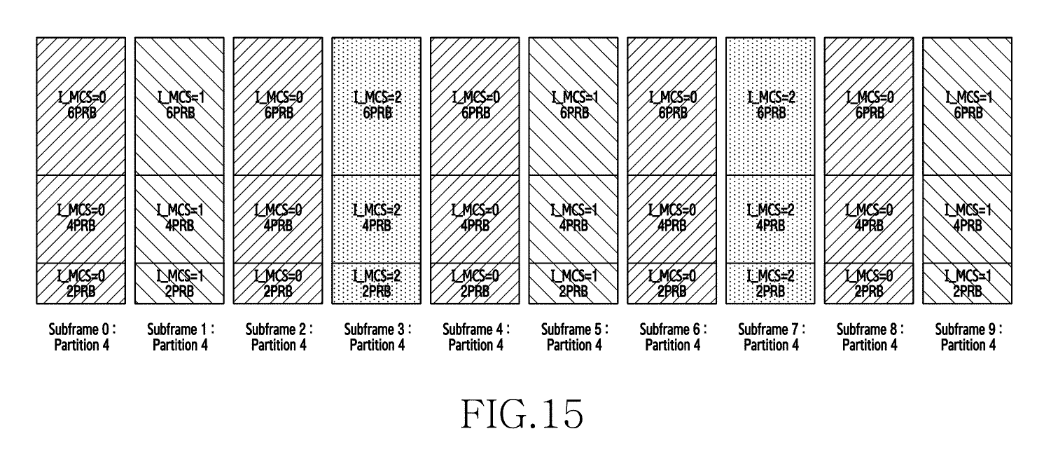

The specific mapping schemes are as shown in FIG. 15.

Scenario 7: For a low-data-volume scenario, it may be considered that subframes 0, 3, 6 and 9 employ partition 5, while the remaining subframes employ partition 4. Therefore, there are six 6-resource-block combinations, fourteen 4-resource-block combinations and fourteen 2-resource-block combinations in one frame. For a high-rate scenario, among the 6-resource-block combinations, the number ratio of three MCSs is as follows: I_MCS0:I_MCS1:I_MCS2=1:2:3; while among the 4-resource-block combinations and the 2-resource-block combinations, the number ratio of three MCSs is as follows: I_MCS0:I_MCS1:I_MCS2=1:2:4.

For the 2-resource-block combinations and the 4-resource-block combinations: I_MCS=2−(n mod 3), n<=4; and I_MCS=(2+n) mod 3, n>=5.

For the 6-resource-block combinations: I_MCS=(9−n) mod 3, n=1, 2, 4, 7, 8; and I_MCS=0, n=5.

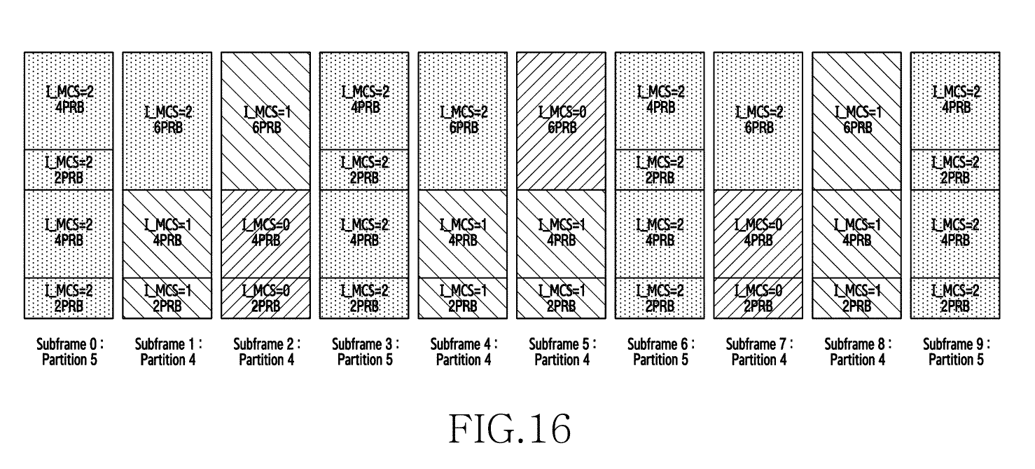

The specific mapping schemes are as shown in FIG. 16.

Scenario 8: for a low-data-volume scenario, it may be considered that subframes 0, 3, 6 and 9 employ partition 5, while the remaining subframes employ partition 4. Therefore, there are six 6-resource-block combinations, fourteen 4-resource-block combinations and fourteen 2-resource-block combinations in one frame. For a medium-rate scenario, among the 6-resource-block combinations, the number ratio of three MCSs is as follows: I_MCS0:I_MCS1:I_MCS2=1:1:1; while among the 4-resource-block combinations and the 2-resource-block combinations, the number ratio of three MCSs is as follows: I_MCS0:I_MCS1:I_MCS2=2:3:2.

For the 2-resource-block combinations and the 4-resource-block combinations: I_MCS=2*(n/3 mod 2), n=0, 3, 6, 9; I_MCS=I_MCS=log 2(n), n=1, 2, 4; I_MCS=2−log 2(9−n), n=5, 7, 8.

For the 6-resource-block combinations: I_MCS=1, n=1, 2, 4, 5, 7, 8.

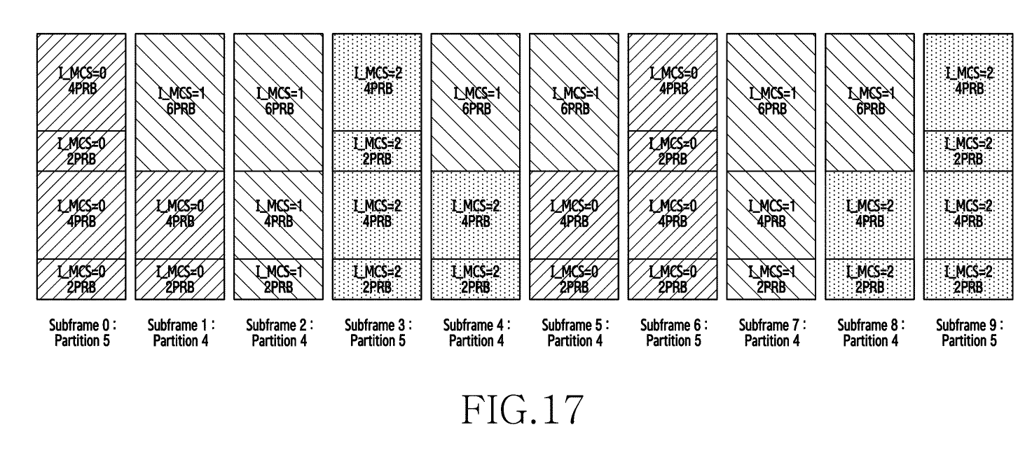

The specific mapping schemes are as shown in FIG. 17.

Scenario 9: For a low-data-volume scenario, it may be considered that subframes 0, 3, 6 and 9 employ partition 5, while the remaining subframes employ partition 4. Therefore, there are six 6-resource-block combinations, fourteen 4-resource-block combinations and fourteen 2-resource-block combinations in one frame. For a low-rate scenario, among the 6-resource-block combinations, the number ratio of three MCSs is as follows: I_MCS0:I_MCS1:I_MCS2=4:2:1; while among the 4-resource-block combinations and the 2-resource-block combinations, the number ratio of three MCSs is as follows: I_MCS0:I_MCS1:I_MCS2=3:2:1.

For the 2-resource-block combinations and the 4-resource-block combinations: I_MCS=(n mod 3), n=0, 1, 2, 3, 4; and I_MCS=(9−n) mod 3, n=5, 6, 7, 8, 9.

For the 6-resource-block combinations: I_MCS=(n−1) mod 3, n=1, 2, 4, 7, 8; and I_MCS=2, n=5.

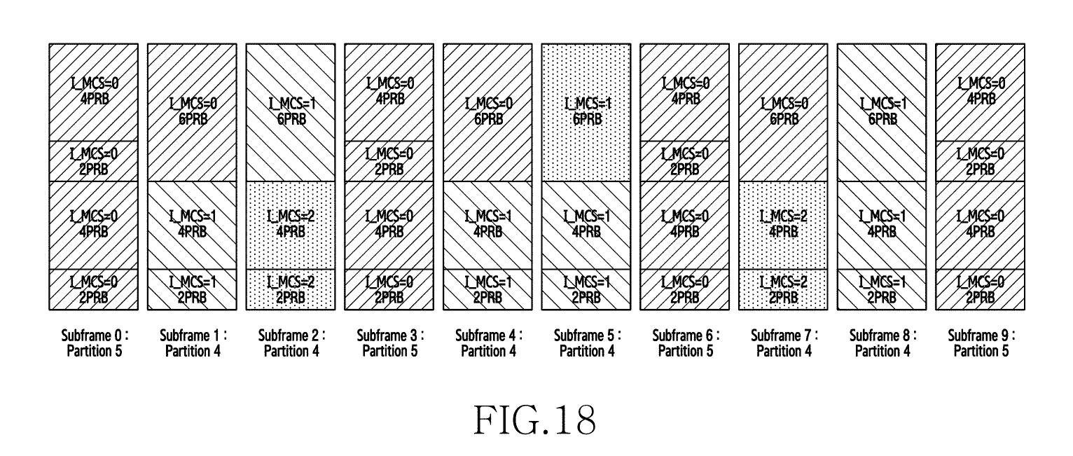

The specific mapping schemes are as shown in FIG. 18.

The base station configures the rules of mapping between the resource partitioning schemes of subframes and the MCSs, according to the use condition of resources in one or more frames (one frame includes ten subframes) and the link performances in the past. Wherein, the Scenario 5 can be used as the defaulted use condition, while other eight scenarios can be expressed by 3 bits. The 3 bits are embedded into the end of the common signaling (common control signaling or broadcast information) in the aforementioned embodiment, and a terminal can periodically detect the configuration condition of the rules of mapping between the resource partitioning schemes and the MCSs. If the 3-bit information is not detected, it is indicated that the defaulted scheme, i.e., Scenario 5, is used as the rules of mapping between the resource partitioning schemes and the MCSs.

It is to be noted that, as a preferred implementation, a base station can allocate resource pool information containing multiple access resources and DMRSs for grant-free transmission, and transmit the resource pool information to a terminal apparatus. Correspondingly, the terminal apparatus receives the resource pool information containing various kinds of multiple access resources and DMRS resources transmitted by the base station apparatus; and then, the terminal apparatus selects, from a resource pool corresponding to the received resource pool information, a modulation and coding scheme and the number of resource blocks for uplink data transmission according to the power control information, the channel state information, the size of a data packet and/or the interference intensity information.

As another preferred implementation, the base station can allocate resource configuration information containing multiple access resources and DMRS resources for the grant-free transmission of a multiple of terminal apparatuses, and transmit the corresponding resource configuration information to the multiple of terminal apparatuses. Correspondingly, the terminal apparatuses receive the resource configuration information containing multiple access resources and DMRS resources transmitted by the base station apparatus; and then, the terminal apparatuses adjust the received resource configuration information according to the power control information, the channel state information, multiple access resources information, the size of a data packet and/or the interference intensity information, so as to determine a modulation and coding scheme and the number of resource blocks for uplink data transmission.

Specifically, the way of allocating resource configuration information containing multiple access resources and DMRS resources for grant-free transmission comprises: allocating a same DMRS and/or a same multiple access resource for a first number of a multiple of terminal apparatuses if detecting that the current network load is less than a first load threshold; and allocating a same DMRS and/or a same multiple access resource for a second number of a multiple of terminal apparatuses if detecting that the current network load is greater than the first load threshold; wherein the first number is greater than the second number.

More preferably, based on change information of the current network load, the allocated resource configuration information for grant-free transmission for a multiple of terminal apparatuses is adjusted.

Two different modes for allocating resources based on grant-free transmission will be described in this embodiment.

The first grant-free resource allocation mode is as follows: a base station allocates a resource pool for a grant-free transmission mode, the resource pool containing multiple access resources and DMRS resources. If a terminal needs to transmit uplink data in a grant-free manner, DMRSs and multiple access resources are selected from the resource pool in an equal probability manner for processing the uplink data, and then time-frequency resources for grant-free transmission are selected in an equal probability manner for transmitting the uplink data.

If the grant-free transmission is performed in this way, the terminal is only required to acquire resource pool information for the grant-free transmission and time-frequency resources allocated for the grant-free transmission, through a high-layer signaling, system information in a broadcast channel/a downlink control channel, or system information in a downlink shared channel. If a user needs to transmit data, DMRS and multiple access resources are randomly selected from the resource pool, and time-frequency resources are randomly selected, for processing and transmitting the data.

In this way, the MCS determination method (modulation and coding scheme determination method) provided by the present disclosure is still applicable. That is, there is a mapping relation between time-frequency resources and MCSs. If a terminal needs to transmit uplink data, the terminal selects an appropriate MCS and time-frequency resources according to the transmitting power of resource blocks, channel state information, multiple access resource information, the size of a data block and/or interference intensity information, and randomly selects multiple access resources and DMRSs to process the data to be transmitted and transmit the data.

The second grant-free resource allocation mode is as follows: a base station configures a DMRS and a multiple access resource for grant-free transmission for each terminal, and the terminal uses the configured DMRS and multiple access resource to select time-frequency resources for grant-free transmission if the terminal needs to transmit uplink data.

If the grant-free transmission is performed in this mode, the terminal has been connected, i.e., has accomplished downlink synchronization, and has accomplished uplink synchronization and allocation of a UE ID through a random access process. The base station configures a DMRS and a multiple access resource for the terminal through a high-layer signaling or information in a downlink control channel/a downlink shared channel. If the terminal needs to transmit data, the terminal uses the allocated DMRS and multiple access resource to perform data transmission on time-frequency resources for the grant-free transmission, without requiring the uplink grant of the base station.

For the grant-free transmission in the massive machine-type communications (mMTC) scenario in 5G, a base station can allocate the same DMRSs and multiple access resources for different terminals. In this case, during the uplink data transmission, different terminals may conflict with each other due to the use of the same multiple access resources and/or DMRSs. By adjusting the number of terminals allocated with the same multiple access resources and/or DMRSs according to the network load, the base station can obtain a trade-off between the terminal access performance and the number of terminals accessed.

Specifically, if the base station detects that the current network load is low, that is, the current network load is less than a preset first threshold, the base station allocates the same DMRSs and/or multiple access resources to the less terminals, so that the probability of conflict occurred if transmitting data by the terminals is reduced and the performance of the terminals in transmitting uplink data is improved; and, if the base station detects that the current network load is high, that is, the current network load is greater than the preset first threshold, the base station allocates the same DMRSs and/or multiple access resources to more terminals, so that probability of conflict occurred if transmitting uplink data by the terminals is increased and the performance is reduced, however, the number of terminals that can access to the network is increased.

The base station also can adaptively adjust the DMRSs and/or multiple access resources allocated to terminals. If the base station detects that the current network load changes, and if the current network load is dropped below a preset second threshold from a higher network load and the number of terminals allocated with a same modulation reference signal and/or multiple access resource is large, the base station allocates channel DMRSs and/or multiple address resources for some terminals, and informs users of the change in resources through a high-layer signaling or a downlink control channel/shared channel.

In this way, a terminal can select an appropriate MCS and appropriate time-frequency resources according to the transmitting power on the time-frequency resources allocated for the grant-free transmission, channel state information, multiple access resource information, the size of a data block and/or interference intensity information, and randomly select multiple access resources and DMRSs to process the data to be transmitted and transmit the data. That is, the forgoing MCSs and time-frequency resource selection ways are still applicable.

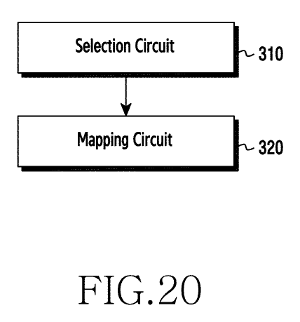

An embodiment of the present disclosure further provides a terminal apparatus for selecting an MCS and the number of resource blocks, as shown in FIG. 20, specifically comprising: a selection circuit 310 configured to select an MCS and the number of resource blocks for uplink data transmission according to power control information, channel state information, multiple access resource information, the size of a data packet and/or interference intensity information; and, a mapping circuit 320 configured to partition resource blocks within a frequency band according to a pre-defined resource partitioning and mapping pattern, and transmit data through the partitioned resource block combination, the partitioned resource block combination being corresponding to the selected MCS and the selected number of resource blocks.

In this embodiment of the present disclosure, the specific function implementation of the selection circuit 310 and the mapping circuit 320 in the terminal apparatus can refer to the specific implementation of each step of the method for determining an MCS and the number of resource blocks and the steps of the resource partitioning and modulation and coding mapping pattern in the aforementioned embodiments, and will not be repeated here.

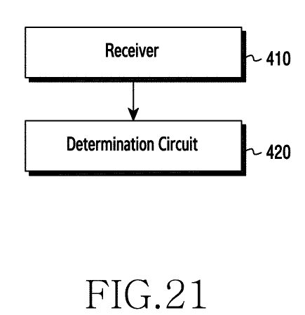

An embodiment of the present disclosure further provides a base station apparatus for determining an MCS and the number of resource blocks, as shown in FIG. 21, specifically comprising: a receiver 410 configured to receive data transmitted by a terminal apparatus through a multiple of resource block combinations; and, a determination circuit 420 configured to determine an MCS corresponding to each resource block combination according to a pre-defined resource partitioning and mapping pattern, so as to determine an MCS and the number of resource blocks for uplink data transmission selected by the terminal apparatus.

In this embodiment of the present disclosure, the specific function implementation of the receiver 410 and the determination circuit 420 in the base station apparatus can refer to the specific implementation of the steps of the resource partitioning and modulation and coding mapping pattern in the aforementioned embodiment, and will not be repeated here.

The foregoing descriptions are merely some implementations of the present disclosure. It should be noted that, to a person of ordinary skill in the art, various improvements and modifications may be made without departing from the principle of the present disclosure, and these improvements and modifications shall be regarded as falling into the protection scope of the present disclosure.

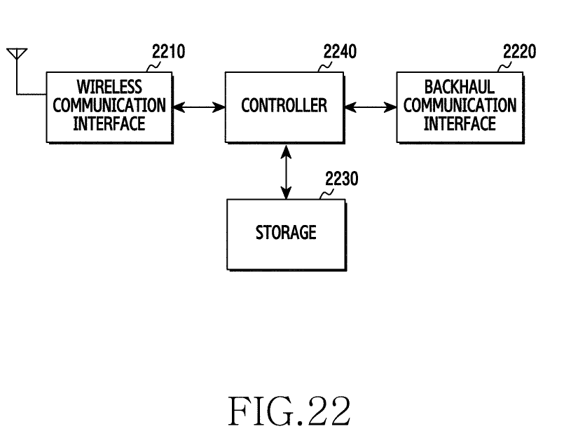

FIG. 22 illustrates a configuration of a base station in a wireless communication system according to various embodiments of the present disclosure. The configuration illustrated in FIG. 22 may be understood as a configuration of one of aforementioned base stations. The terms “ . . . unit,” “ . . . device,” etc. used below refer to a unit for processing at least one function or operation, and may be implemented as hardware, software, or a combination of hardware and software.

Referring to FIG. 22, the base station may include a wireless communication interface 2210, a backhaul communication interface 2220, a storage 2220, and a controller 2240.

The wireless communication interface 2210 performs functions for transmitting or receiving a signal through a wireless channel. For example, the wireless communication interface 2210 performs conversion between a baseband signal and a bit string according to the physical layer standard of the system. For example, if data is transmitted, the wireless communication interface 2210 generates complex symbols by encoding and modulating a transmission bit string. Further, if data is received, the wireless communication interface 2210 restores a reception bit string by demodulating and decoding a baseband signal. In addition, the wireless communication interface 2210 up-converts a baseband signal to a radio frequency (RF) band signal, transmits the up-converted signal through an antenna, and down-converts an RF band signal received through the antenna to a baseband signal.

To this end, the wireless communication interface 2210 may include a transmission filter, a reception filter, an amplifier, a mixer, an oscillator, a digital to analog converter (DAC), an analog to digital converter (ADC), and the like. In addition, the wireless communication interface 2210 may include a plurality of transmission/reception paths. Further, the wireless communication interface 2210 may include at least one antenna array including a plurality of antenna elements. In terms of hardware, the wireless communication interface 2210 may include a digital circuit and an analog circuit, and the analog circuit may include a plurality of sub-circuits according to an operation power, an operation frequency, and the like.

As described above, the wireless communication interface 2210 transmits and receives a signal. Accordingly, all or a part of the wireless communication interface 2210 may be referred to as a “transmitter”, a “receiver” or a “transceiver.” In addition, in the following description, the meaning of transmission and reception performed through a wireless channel includes performing of processing, such as that described above, by the wireless communication interface 2210.

The backhaul communication interface 2220 provides an interface for performing communication with other nodes within a network. That is, the backhaul communication interface 2220 converts a bit string transmitted from the base station to another node, for example, another access node, another base station, an upper node, a core network, etc., into a physical signal, and converts a physical signal received from another node into a bit string.

The storage 2230 stores data, such as a basic program for operation of the base station, an application program, and configuration information. The storage 2230 may include a volatile memory, a nonvolatile memory, or a combination of a volatile memory and a nonvolatile memory. Further, the storage 2230 provides stored data in response to a request from the controller 2240.

The controller 2240 controls the overall operation of the base station. For example, the controller 2240 transmits and receives a signal through the wireless communication interface 2210 or through the backhaul communication interface 2220. In addition, the controller 2240 records data in the storage 2230 and reads the data. Further, the controller 2240 may perform functions of a protocol stack required by the communication standard. To this end, the controller 2240 may include at least one processor. According to various embodiments, the controller 2240 controls to receive data transmitted by a terminal through a multiple of resource block combinations and determine an MCS corresponding to each resource block combination according to a pre-defined resource partitioning and mapping pattern. For example, the controller 2240 may control the base station to perform operations according to various embodiments as aforementioned.

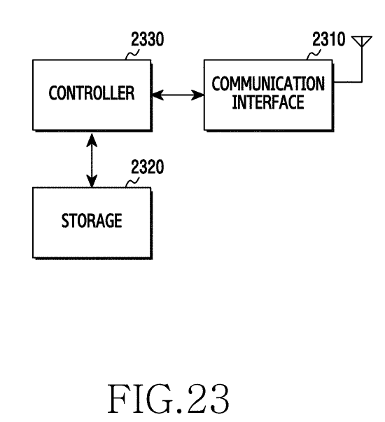

FIG. 23 illustrates a configuration of a terminal in a wireless communication system according to various embodiments of the present disclosure. The configuration illustrated in FIG. 23 may be understood as a configuration of one of aforementioned terminals. The terms “ . . . unit,” “ . . . device,” etc. used below refer to a unit for processing at least one function or operation, and may be implemented as hardware, software, or a combination of hardware and software.

Referring to FIG. 23, the terminal includes a communication interface 2310, a storage 2320, and a controller 2330.

The communication interface 2310 performs functions for transmitting or receiving a signal through a wireless channel. For example, the communication interface 2310 performs conversion between a baseband signal and a bit string according to the physical layer standard of the system. For example, if data is transmitted, the communication interface 2310 generates complex symbols by encoding and modulating a transmission bit string. Further, if data is received, the communication interface 2310 restores a reception bit string by demodulating and decoding a baseband signal. In addition, the communication interface 2310 up-converts a baseband signal to an RF band signal, transmits the up-converted signal through an antenna, and down-converts an RF band signal received through the antenna to a baseband signal. For example, the communication interface 2310 may include a transmission filter, a reception filter, an amplifier, a mixer, an oscillator, a DAC, an ADC, and the like.

In addition, the communication interface 2310 may include a plurality of transmission/reception paths. Further, the communication interface 2310 may include at least one antenna array including a plurality of antenna elements. In terms of hardware, the communication interface 2310 may include a digital circuit and an analog circuit (e.g., a radio frequency integrated circuit (RFIC)). Here, the digital circuit and the analog circuit may be implemented as a single package. In addition, the communication interface 2310 may include a plurality of RF chains. Furthermore, the communication interface 2310 may perform beamforming.

As described above, the communication interface 2310 transmits and receives a signal. Accordingly, all or a part of the communication interface 2310 may be referred to as a “transmitter”, a “receiver” or a “transceiver.” In addition, in the following description, the meaning of transmission and reception performed through a wireless channel includes performing of processing, such as that described above, by the communication interface 2310.

The storage 2320 stores data, such as a basic program for operation of the terminal, an application program, and configuration information. The storage 2320 may include a volatile memory, a nonvolatile memory, or a combination of a volatile memory and a nonvolatile memory. Further, the storage 2320 provides stored data in response to a request from the controller 2330.

The controller 2330 controls the overall operation of the terminal. For example, the controller 2330 transmits and receives a signal through the communication interface 2310. In addition, the controller 2330 records data in the storage 2320 and reads the data. Further, the controller 2330 may perform functions of a protocol stack required by the communication standard. To this end, the controller 2330 may include at least one processor or a microprocessor, or may be part of a processor. Further, the controller 2330 and a part of the communication interface 2310 may be referred to as a communication processor (CP).

According to various embodiments, the controller 2330 control to select an MCS and a number of resource blocks for uplink data transmission according to at least one of power control information, channel state information, multiple access resource information, the size of a data packet or interference intensity information, partition resource blocks within a frequency band according to a pre-defined resource partitioning and mapping pattern, and transmit data through the partitioned resource block combination. For example, the controller 2330 may control the terminal to perform operations according to various embodiments as aforementioned.

Methods according to embodiments stated in claims and/or specifications of the present disclosure may be implemented in hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the present disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of the may form a memory in which the program is stored. Further, a plurality of such memories may be included in the electronic device.

In addition, the programs may be stored in an attachable storage device which is accessible through communication networks such as the Internet, Intranet, local area network (LAN), wide area network (WAN), and storage area network (SAN), or a combination thereof. Such a storage device may access the electronic device via an external port. Further, a separate storage device on the communication network may access a portable electronic device.

In the above-described detailed embodiments of the present disclosure, a component included in the present disclosure is expressed in the singular or the plural according to a presented detailed embodiment. However, the singular form or plural form is selected for convenience of description suitable for the presented situation, and various embodiments of the present disclosure are not limited to a single element or multiple elements thereof. Further, either multiple elements expressed in the description may be configured into a single element or a single element in the description may be configured into multiple elements.

While the present disclosure has been shown and described with reference to certain embodiments thereof, it will be understood by those skilled in the art that various changes in form and details may be made therein without departing from the scope of the present disclosure. Therefore, the scope of the present disclosure should not be defined as being limited to the embodiments, but should be defined by the appended claims and equivalents thereof.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for operating a terminal in a wireless communication system, the method comprising:
selecting a modulation and coding scheme (MCS) and a number of resource blocks for an uplink data transmission according to at least one of power control information, channel state information, multiple access resource information, a size of a data packet, or interference intensity information;
partitioning resource blocks within a frequency band according to a pre-defined resource partitioning and mapping pattern; and
transmitting data through a combination of the partitioned resource blocks,
wherein the combination of the partitioned resource blocks corresponds to the selected MCS and the selected number of resource blocks.

2. The method of claim 1, wherein selecting the MCS and the number of resource blocks comprises:
determining a transmit power of each resource block according to the power control information;
identifying a signal-to-interference-plus-noise ratio (SINK) to determine the MCS according to at least one of the determined transmit power of each resource block and in a combination of the multiple access resource information, the channel state information, or the interference intensity information;
determining the number of resource blocks according to the transmit power of each resource block and a pre-defined maximum power limit; and
adjusting the MCS and the number of resource blocks according to the size of the data packet to determine the MCS and the number of resource blocks for the uplink data transmission.

3. The method of claim 2, further comprising:
determining a power control mode according to a high-layer signaling from a base station; and
determining a transmit power of each resource block according to the power control mode.

4. The method of claim 3, further comprising
if the power control mode is an open-loop power control mode based on different path loss compensations, adjusting the transmit power of each resource block based on the MCS.

5. The method of claim 2, wherein adjusting the MCS and the number of resource blocks further comprises:
determining an MCS and a number of resource blocks as the MCS and the number of resource blocks for the uplink data transmission if a number of data blocks corresponding to the MCS and the number of resource blocks is less than or equal to the size of the data packet; and
selecting, by at least one of decreasing the number of resource blocks or lowering MCS level if the number of data blocks corresponding to the MCS and the number of resource blocks is greater than the size of the data packet, the MCS and the number of resource blocks corresponding to a minimum data block that is greater than the size of the data packet as the MCS and the number of resource blocks for the uplink data transmission.

6. The method of claim 1, further comprising
acquiring the interference intensity information by receiving at least one of broadcast information or a common control signaling, a high-layer signaling for an interference feedback from a base station, or the interference intensity information obtained by performing interference measurement on time-frequency resources for a grant-free system by the base station.

7. The method of claim 6, wherein acquiring the interference intensity information comprises:
if there is a reference signal in the frequency band of the grant-free system, obtaining the interference intensity information by performing channel estimation and subtracting a result of the channel estimation based on a signal received from the base station; and
if there is no reference signal and data transmission in the frequency band of the grant-free system, determining the interference intensity information according to an intensity measurement performed on the signal received from the base station.

8. The method of claim 6, wherein the interference intensity information is obtained by:
determining a maximum interference intensity and a minimum interference intensity according to a radius of a serving cell and a radius of a neighboring cell; and
quantizing an interference intensity according to the maximum interference intensity and the minimum interference intensity to obtain the interference intensity information.

9. The method of claim 1, further comprising
determining a resource partitioning and mapping pattern using at least one of a common control signaling or a high-layer signaling received from a base station, wherein the at least one of the common control signaling or the high-layer signaling comprises an application scenario number corresponding to the resource partitioning and mapping pattern.

10. The method of claim 9, wherein determining the resource partitioning and mapping pattern further comprises at least one:
partitioning the resource blocks in the frequency band into resource block combinations each of which comprises a same size; or
partitioning the resource blocks in the frequency band into resource block combinations each of which comprises different size.

11. The method of claim 1, further comprising:
determining resource pool information of multiple access resources and demodulation reference signal (DMRS) resources received from a base station,
wherein selecting the MCS and the number of resource blocks for the uplink data transmission further comprises
selecting, from a resource pool corresponding to the resource pool information, the MCS and the number of resource blocks for the uplink data transmission according to the at least one of the power control information, the channel state information, the multiple access resource information, the size of a data packet, or the interference intensity information.

12. The method of claim 1, further comprising
determining resource configuration information containing multiple access resources and DMRS resources received from a base station.

13. A method operating a base station in a wireless communication system, the method comprising:
receiving, from a terminal, data from through a multiple of resource block combinations; and
identifying an MCS corresponding to each resource block combination according to a pre-defined resource partitioning and mapping pattern to determine an MCS and a number of resource blocks for an uplink data transmission selected by the terminal.

14. The method of claim 13, further comprising:
performing interference measurement on a frequency band for a grant-free transmission to determine interference intensity information; and
transmitting the interference intensity information through at least one of broadcast information, a common control signaling, or a high-layer signaling for an interference feedback.

15. The method of claim 14, wherein performing interference measurement comprises,
if there is a reference signal in a frequency band of a grant-free system, performing channel estimation and subtracting a result of the channel estimation based on a signal received from the base station to determine the interference intensity information; and
if there is no reference signal and data transmission in the frequency band of the grant-free system, determining the interference intensity information according to an intensity measurement performed on the signal received from the base station.

16. The method of claim 15, further comprising:
if a total power of the received signal is greater than a pre-defined threshold, determining that there is a reference signal in the frequency band of the grant-free system; and
if the total power of the received signal is less than the pre-defined threshold, determining that there is no reference signal and data transmission in the frequency band of the grant-free system.

17. The method of claim 14, wherein performing interference measurement comprises:
determining a maximum interference intensity and a minimum interference intensity according to a radius of a serving cell and a radius of a neighboring cell; and
quantizing the interference intensity according to the maximum interference intensity and the minimum interference intensity to obtain the interference intensity information.

18. The method of claim 13, further comprising:
transmitting a pre-defined resource partitioning and mapping pattern through at least one of a common control signaling, or a high-layer signaling, the at least one of the common control signaling the high-layer signaling comprising an application scenario number corresponding to the pre-defined resource partitioning and mapping pattern.

19. A terminal in a wireless communication system, the terminal comprising:
at least one processor configured to:
select a modulation and coding scheme (MCS) and a number of resource blocks for an uplink data transmission according to at least one of power control information, channel state information, multiple access resource information, a size of a data packet, or interference intensity information, and
partition resource blocks within a frequency band according to a pre-defined resource partitioning and mapping pattern; and
a transceiver configured to transmit data through a combination of the partitioned resource block,
wherein the combination of the partitioned resource block corresponds to the selected MCS and the selected number of resource blocks.

20. The terminal of claim 19, wherein the at least one processor is further configured to:
determine a transmit power of each resource block according to the power control information;
identify a signal-to-interference-plus-noise ratio (SINK) to determine the MCS according to at least one of the determined transmit power of each resource block and in a combination of the multiple access resource information, the channel state information, or the interference intensity information;
determine the number of resource blocks according to the transmit power of each resource block and a pre-defined maximum power limit; and
adjust the MCS and the number of resource blocks according to the size of the data packet to determine the MCS and the number of resource blocks for the uplink data transmission.
